(19) United States
(12) Patent Application Publication
(10) Pub. No.: US 2009/0187680 A1
(43) Pub. Date: Jul. 23, 2009

(54) Controller System With Programmable Bi-directional Terminals

(76) Inventors: Shih-Chieh LIAO, Taoyuan Shien (TW); Shih-Hao Cheng, Taoyuan Shien (TW)

Correspondence Address: HDLS Patent & Trademark Services, P.O. BOX 220746, CHANTILLY, VA, 20153-0746, US

(21) Appl. No.: 12/017,325

(22) Filed: Jan. 21, 2008

(51) Int. Cl. G06F 13/00

(52) U.S. Cl. 710/31

(57) ABSTRACT

A controller system with programmable bi-directional input/output terminals includes a micro controller, a terminal block and an interface unit connected between the micro controller and the terminal block. The interface unit includes a predetermined number of uni-directional input terminals, a predetermined number of uni-directional output terminals, and a predetermined number of bi-directional terminals. The micro controller can selectively set the bi-direction terminals as input terminals or output terminals according to an ID signal from the interface unit or a user parameter. Therefore, the number of input/output terminals for the controller system can be flexibly adjusted.

### BACKGROUND OF THE INVENTION

1. Field of the Invention

The present invention relates to a controller system, especially to a controller system with programmable bi-direction terminals.

2. Description of Prior Art

In control system, a controller is connected to sensors, actuators and lamps through an input/output interface for data collection and control function. The input/output interface is electrically connected to the sensors, the actuators and the lamps. Therefore the controller can control lamp, valve and pump through the input/output interface. The controller can also sense the pressing-down of switch or temperature through the input/output interface.

The commercially available inverter or controller uses single-chip micro controller or micro processor as a console, wherein the input/output ports thereof are bi-directional and can be programmed as input or output pins. The input and output interfaces for the single-chip micro controller or micro processor are usually unidirectional and lack of flexibility.

FIG. 1 shows the block diagram of a prior art inverter control system 50. The inverter control system 50 mainly comprises a micro controller 52, a digital input interface 54A, a digital output interface 54B and a terminal block 56. The terminal block 56 is connected to external sensor, actuator, lamp and valve. The digital input interface 54A and the digital output interface 54B provide level conversion or signal isolation between the micro controller 52 and the terminal block 56. Therefore, the micro controller 52 can be used in industrial control application.

However, in above-mentioned inverter control system 50, the digital input interface 54A and the digital output interface 54B are uni-directional and cannot be programmable or changed. When one of the digital input interface 54A and the digital output interface 54B is insufficient, it is necessary to purchase expansion card or use inverter controller system with more input/output terminals. However, in practical situation, the input terminal is excessive and the output terminal is wanting, or vice versa.

Therefore, it is desirable to provide a controller system with programmable bi-direction terminals.

### SUMMARY OF THE INVENTION

It is the object of the present invention to provide a controller system with programmable bi-direction terminals to flexibly set up the number of input and output terminals for the controller system.

Accordingly, the present invention provides a controller system with programmable bi-direction input/output terminals includes a micro controller, a terminal block and an interface unit connected between the micro controller and the terminal block. The interface unit includes a predetermined number of uni-directional input terminals, a predetermined number of uni-directional output terminals, and a predetermined number of bi-directional terminals. The micro controller can selectively set the bi-direction terminals as input terminals or output terminals according to an ID signal from the interface unit or a user parameter. Therefore, the number of input/output terminals for the controller can be flexibly adjusted.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the block diagram of a prior art inverter control system.

FIG. 2 shows the block diagram of a controller system with programmable bi-directional terminal according to the present invention.

FIG. 3 shows the block diagram of a controller system with programmable bi-directional terminal according to another preferred embodiment of the present invention.

FIG. 4 shows a flowchart of operation steps for the micro controller.

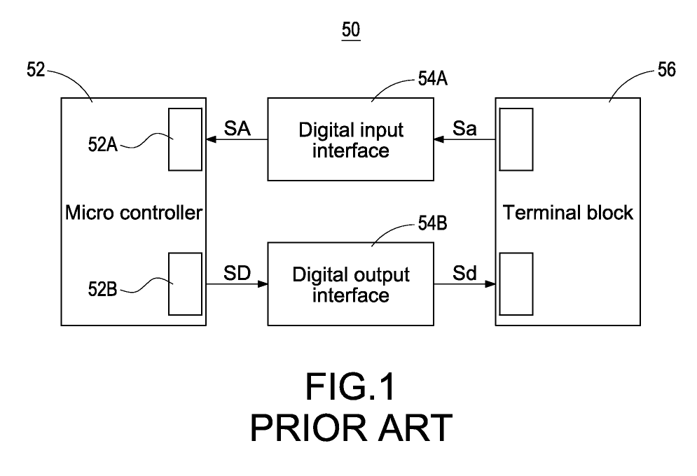

### DETAILED DESCRIPTION OF THE INVENTION

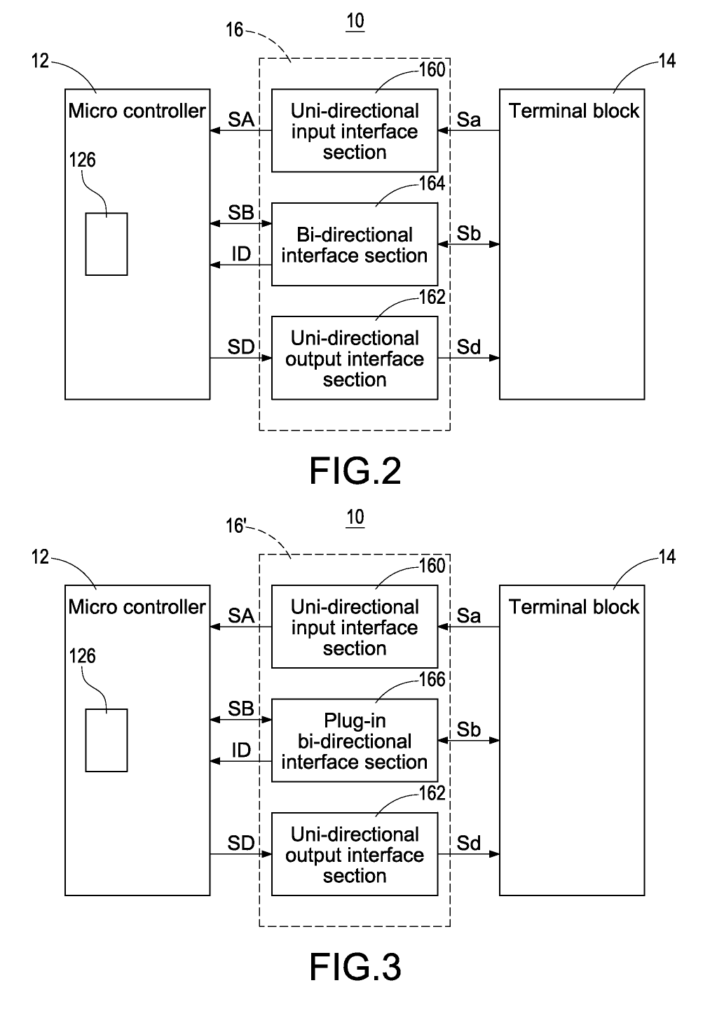

FIG. 2 shows the block diagram of a controller system 10 with programmable bi-directional terminal according to the present invention. The controller system 10 mainly comprises a micro controller 12, a terminal block 14 and an interface unit 16 connected between the micro controller 12 and the terminal block 14. The interface unit 16 comprises a uni-directional input interface section 160 with terminals of first number (such as number M), a uni-directional output interface section 162 with terminals of second number (such as number N), and a bi-directional interface section 164 with terminals of third number (such as number P), wherein the uni-directional input interface section 160, the uni-directional output interface section 162 and the bi-directional interface section 164 have the ability to send digital signal.

The micro controller 12 receives signal SA from the uni-directional input interface section 160, and the micro controller 12 sends signal SD to the uni-directional input interface section 162. Moreover, the micro controller 12 programs the P terminals in the bi-directional interface section 164 into Q input terminals and R output terminals (P=Q+R) according to an identification (ID) signal of the bi-directional interface section 164. Alternatively, the micro controller 12 can also program the terminals of the bi-directional interface section 164 according to a user parameter in a memory (such as a read only memory) 126 therein.

The terminal block 14 sends signal Sa to the uni-directional input interface section 160, wherein the signal Sa is to be sent to the micro controller 12. The terminal block 14 receives signal Sd from the uni-directional output interface section 162, wherein the signal Sd is sent from the micro controller 12. The terminal block 14 sends and receives signal Sb to and from the bi-directional interface section 164, thus communicating with the micro controller 12.

In above mentioned controller system 10, the micro controller 12 programs the P terminals in the bi-directional interface section 164 as input terminals or output terminals (P=Q+R) according to an identification (ID) signal of the bi-directional interface section 164 or a user parameter in a memory (such as a read only memory) 126 therein. Therefore, it is not necessary to set all of the (M+N+P) terminals of the interface unit 16 as bi-directional terminals to save cost. Moreover, the micro controller 12 also sets up the input/output (I/O) ports thereof corresponding to the pin setting of the P terminals in the bi-directional interface section 164. In this preferred embodiment, the micro controller 12 is operated in a full automatic scheme.

Moreover, user can manually set the input/output terminals number of the bi-directional interface section 164 by hardware of the bi-directional interface section 164 or other specific software/hardware. The micro controller 12 also sets up the I/O ports thereof according to the identification (ID) signal of the interface unit 16 or user parameter in the memory thereof, whereby the I/O ports of the micro controller 12 have input/output setting corresponding to the input/output terminals of the bi-directional interface section 164. In this embodiment, the micro controller 12 is operated in a semi-automatic scheme way.

FIG. 3 shows the block diagram of a controller system 10 with programmable bi-directional terminal according to another preferred embodiment of the present invention. The controller system 10 mainly comprises a micro controller 12, a terminal block 14 and a plug-in interface unit 16′ connected between the micro controller 12 and the terminal block 14. The components of FIG. 3 are similar to those of FIG. 2 except that the interface unit 16′ adopts a plug in design and comprises a plug in bi-directional interface section 166. The micro controller 12 also sets up the I/O ports thereof according to the identification (ID) signal of the plug-in interface unit 16′, whereby the l/O ports of the micro controller 12 have input/output setting corresponding to the input/output terminals of the plug-in bi-directional interface section 166.

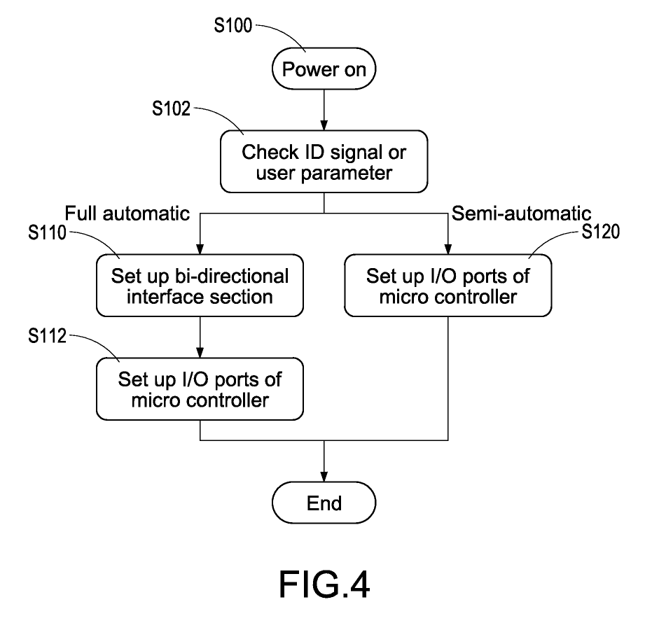

FIG. 4 shows a flowchart of operation steps for the micro controller 12. After power on (S100), the micro controller 12 checks the identification (ID) signal or user parameter in the memory thereof (S102) to determine the P terminals in the bi-directional interface section 164 functioning as input terminals or output terminals. In full automatic operation, the micro controller 12 sets up the P terminals in the bi-directional interface section 164 as input terminals or output terminals based on the identification (ID) signal or user parameter in the memory thereof (S110). The micro controller 12 further sets up the I/O ports thereof to correspond to the arrangement of the bi-directional interface section 164 (S112). In the semi-automatic operation, the micro controller 12 checks the identification (ID) signal or user parameter in the memory thereof (S102) and then only sets up the I/O ports thereof to correspond to the arrangement of the bi-directional interface section 164 (S120). In the semi-automatic operation, the terminals of the bi-directional interface section 164 are already setup by user according to hardware of the bi-directional interface section 164 or other specific software/hardware. It should be noted that the above embodiment is only for demonstration and other modification is possible. For example, the P terminals in the bi-directional interface section 164 can be partially set as input terminals and partially set as output terminals. Therefore, the micro controller 12 can flexibly adjust l/O ports thereof according to identification (ID) signal or user parameter to match practical need.

To sum up, the controller system of the present invention comprises a bi-directional interface section to provide bi-directional terminals and a micro controller able to set up the I/O ports thereof The input and output terminals for the controller system can be flexibly adjusted.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A controller system with bi-directional terminals, comprising:
a micro controller;
a terminal block; and
an interface unit electrically connected between the micro controller and the terminal block, and comprising a uni-directional input interface section with a first number of terminals, a unidirectional output interface section with a second number of terminals and a bi-directional interface section with a third number of terminals;
wherein the micro controller is configured to set up each of the terminals in the bi-directional interface section as one of input and output terminal.

2. The controller system in claim 1, wherein the interface unit is configured to output an identification signal and the micro controller is configured to set up each of the terminals in the bi-directional interface section according to the identification signal.

3. The controller system in claim 1, wherein the micro controller comprises a memory to store a user parameter, the micro controller is configured to set up each of the terminals in the bi-directional interface section according to the user parameter.

4. The controller system in claim 1, wherein the interface unit is a plug in interface unit.

5. A controller system with bi-directional terminals, comprising:
a micro controller with a plurality of input/output ports;
a terminal block; and
an interface unit electrically connected between the micro controller and the terminal block, and comprising a uni-directional input interface section with a first number of terminals, a uni-directional output interface section with a second number of terminals and a bi-directional interface section with a third number of terminals;
wherein the micro controller is configured to set up the input/output ports thereof as input port or output port corresponding to the bi-directional interface section, whereby input and output terminals of the controller system can be flexibly adjusted.

6. The controller system in claim 5, wherein the interface unit is configured to output an identification signal and the micro controller is configured to set up each of the input/output ports thereof according to the identification signal.

7. The controller system in claim 5, wherein the micro controller comprises a memory to store a user parameter, the micro controller is configured to set up each of the input/output ports thereof according to the user parameter.

8. The controller system in claim 5, wherein the interface unit is a plug in interface unit.
